(19) United States
(12) Patent Application Publication
(10) Pub. No.: US 2025/0140095 A1
(43) Pub. Date: May 1, 2025

(54) CONTAINER SENSOR ASSEMBLY, SYSTEM, AND METHOD

(71) Applicant: ENERGY STORAGE SAFETY PRODUCTS INTERNATIONAL LLC, Detroit, MI (US)

(72) Inventor: Ronald M. Butler, West Bloomfield, MI (US)

(21) Appl. No.: 18/933,347

(22) Filed: Oct. 31, 2024

Related U.S. Application Data
(60) Provisional application No. 63/594,794, filed on Oct. 31, 2023.

(51) Int. Cl. G08B 17/10; A62C 8/06; G08B 7/06; G08B 25/10

(52) U.S. Cl. CPC G08B 17/10; A62C 8/06; G08B 7/06; G08B 25/10

(57) ABSTRACT

The present disclosure provides a container sensor device for detecting a thermal event in a container. The container sensor device can include a housing, a detection module, and a blanket. The housing can be formed of a temperature resistant material. The detection module can be disposed adjacent the hollow interior of the housing and can include a sensor packet, a controller, a light source, an audio source, and a power source. The sensor packet can include a sensor capable of detecting the thermal event and can be adapted to monitor for a thermal event associated with a container. The sensor can detect heat, heat vented rise, humidity, pressure, and tilt of the housing. The blanket can be formed from a temperature resistant material and formed to cover the container.

### CROSS-REFERENCE TO RELATED APPLICATIONS

This application claims the benefit of U.S. Provisional Application No. 63/594,794, filed on Oct. 31, 2023. The entire disclosure of the above application is incorporated herein by reference.

### FIELD

The present technology relates to container monitoring devices and, more particularly, a sensorized device for detection of thermal events within containers.

### INTRODUCTION

This section provides background information related to the present disclosure which is not necessarily prior art.

Shipping containers have transformed the global logistics industry by standardizing the shipping and transportation process. One of the main purposes of these shipping containers is to transport goods from one place to another without damaging the goods. Through containers, cargo can be transported anywhere in the world by any means of transport with ease and in one of the most cost-effective ways. Containers can be very strong and highly durable in nature so that the container can be re-used in long-distance transit global trades.

One approach to monitoring and detecting thermal events associated with shipping containers involves manual inspection or the use of separate monitoring devices that are not integrated with the container itself. Manual inspection requires regular physical checks, which can be time-consuming and might not provide real-time monitoring. Separate monitoring devices often require additional equipment and wiring, making them cumbersome and less practical for widespread use.

Some solutions have attempted to incorporate sensors into shipping containers to enable monitoring of thermal events. However, these approaches have been limited in their functionality and capabilities. For example, some shipping containers can only include a single sensor for detecting heat, which might not provide a comprehensive assessment of potential fire hazards. Other shipping containers can lack sensors for detecting other important parameters such as heat vented rise, humidity, pressure, and tilt, which can also be indicative of potential fire risks. Additionally, most approaches do not take into consideration a fire suppression mechanism to allow for an extended response time.

Accordingly, there is a need for a container sensor device that allows for real-time monitoring of thermal events associated with shipping containers, and which provides visual and audio alerts as well as fire suppression.

### SUMMARY

In concordance with the instant disclosure, a container sensor device that allows for real-time monitoring of thermal events associated with shipping containers, and which provides visual and audio alerts as well as fire suppression, has surprisingly been discovered.

The present technology includes articles of manufacture, systems, and processes that relate to articles of manufacture, systems, and processes that relate to monitoring of shipping containers. The present disclosure aims to address these limitations by providing a container sensor device that integrates a detection module with sensors capable of detecting either an undesirable thermal event or an active fire in a container having the container sensor device, along with a controller, light source, speaker, and power source.

The present disclosure provides a container sensor device for detecting a thermal event in a container. The container sensor device can include a housing, a detection module, and a blanket. The housing can be formed of a temperature resistant material. The housing can include a base wall, a cover wall, and a hollow interior. The base wall can be configured to be disposed adjacent an outer surface of the container. The cover wall can have a vent for allowing airflow into the hollow interior of the housing. The detection module can be disposed adjacent the hollow interior of the housing and can include a sensor packet, a controller, a light source, an audio source, and a power source. The sensor packet can include sensors capable of detecting an active fire and can be adapted to monitor for a thermal event associated with a container. The sensors can include at least one sensor for detecting heat, heat vented rise, humidity, pressure, and tilt of the housing. The controller can be in communication with the sensor packet and can be configured to receive and process data from the sensor packet. The light source can be in communication with the controller and configured to provide a visual alert. The audio source can be in communication with the controller and configured to provide an audio alert. The power source can supply power to the detection module. The blanket can be formed from a temperature resistant material and formed to cover the container.

The present disclosure also provides a system for detecting the occurrence of a thermal event. The system can include a container, a container sensor device, and a user device. The container can include an outer surface and an opening formed therethrough. The system can include the container sensor device, as described herein. The user device can be in communication with the container sensor device and can be configured to receive a signal indicative of an alert from the container sensor device.

The present disclosure further provides a method for detecting a thermal event. The method can include providing the container and container sensor device as described herein. The method can include a step of installing the container sensor device onto the outer surface of the container adjacent to the opening formed in the container. The container sensor device can monitor the container and alert a user in case of the thermal event being detected during the monitoring of the container.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a top perspective view of a container sensor device installed on a container;

FIG. 2 is a front elevational view of the container sensor device installed on the container;

FIG. 3 is a side elevational cross-sectional view of the container sensor device installed on the container taken at section line A-A of FIG. 1;

FIG. 4a is a front elevational view of a housing of the container sensor device;

FIG. 4b is a front elevational view of the housing with a cover wall removed to illustrate a detection module;

FIG. 5 is a top perspective view of a blanket installed on the container;

FIG. 6 is a schematic of the container sensor device;

FIG. 7 is an environmental view of a thermal event occurring within a container, while the container is being monitored with a system for detecting the occurrence of the thermal event;

FIG. 8 is a schematic of the system for detecting the occurrence of a thermal event; and

FIG. 9 is a flowchart depicting a method for detecting the occurrence of a thermal event.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

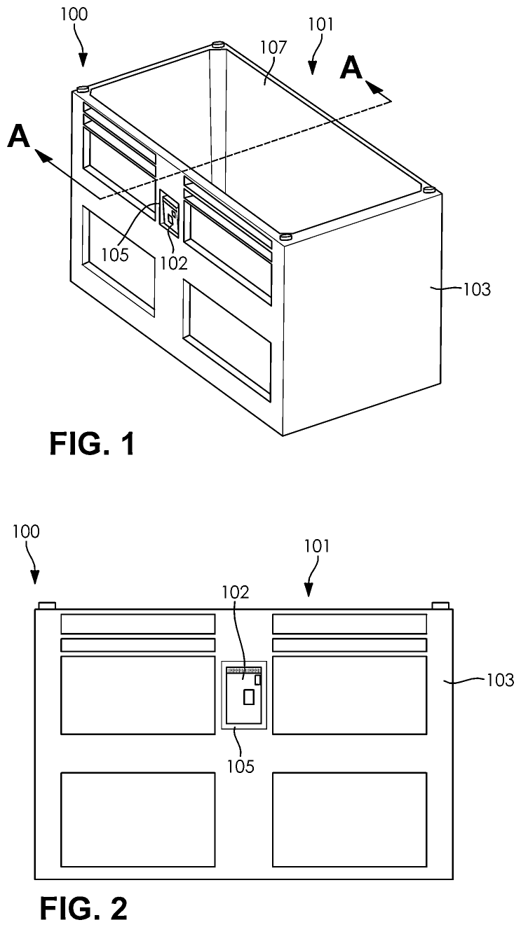

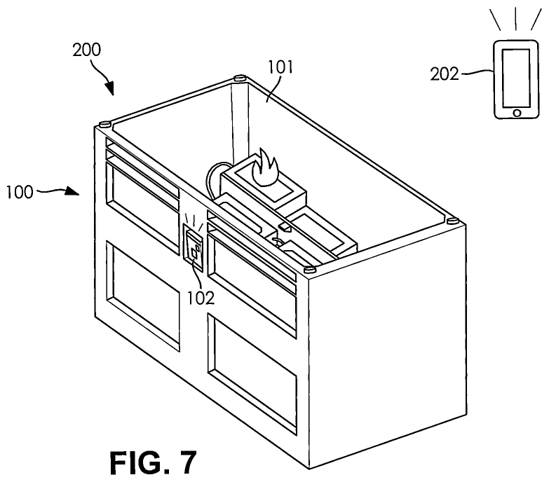

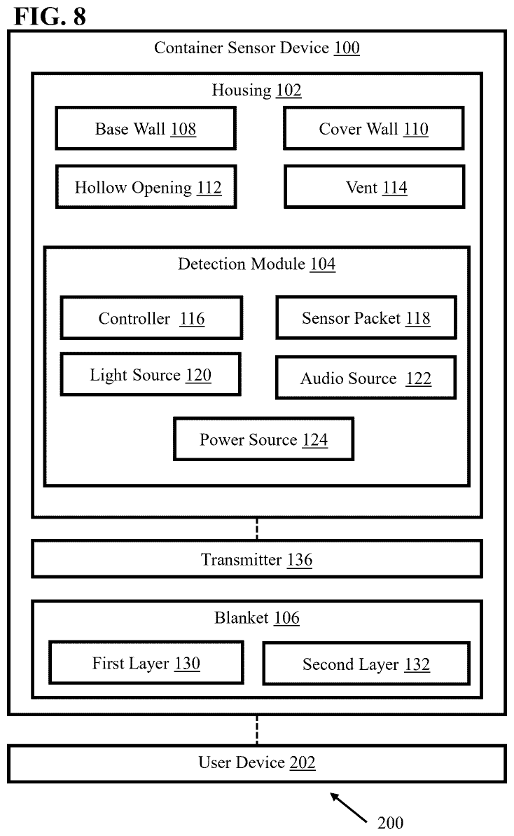

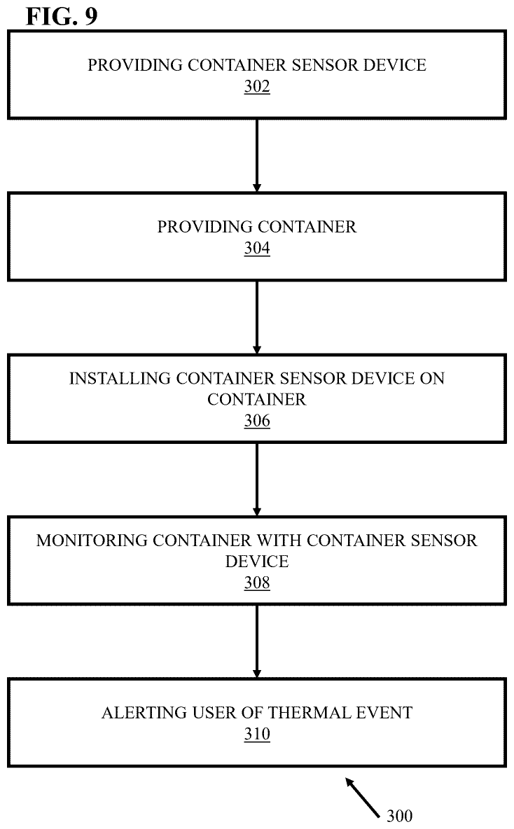

The present technology provides for ways of making and using a container monitoring device for detecting a thermal event of a container, thereby militating against fire in containers at risk of thermal events, such as containers containing batteries as a non-limiting example. A container sensor device 100 for detecting an active fire in a container based on a thermal event is provided, as shown generally in FIGS. 1-6, a system 200 for detecting the occurrence of a thermal event is provided, as shown generally in FIGS. 7-8, and a method 300 for detecting the occurrence of a thermal event is provided, as shown generally in FIG. 9. The present disclosure provides early detection of a thermal event through advanced sensors that can monitor heat, humidity, pressure, and tilt of the container 101. The container sensor device 100 can combine active detection with passive fire suppression via a temperature-resistant blanket that covers the container 101.

As used herein, the term “container” can be defined as any object or system designed to hold, store, or transport batteries securely and efficiently. In various contexts, containers can take many forms, ranging from large shipping containers used in global trade to smaller packaging solutions for everyday items. Examples include metal shipping containers, plastic storage bins, glass jars, cardboard boxes, and bags. The container can be used to hold a battery or a used battery being shipped or transported for recycling.

As used herein, the term “battery” can be defined as any device that stores and provides electrical energy through chemical reactions. The battery can be for use with any type of vehicles including cars, trucks, buses, motorcycles, electric bicycles, trains, golf carts, segways, personal transporters such hoverboards.

As used herein, the term “thermal event” refers to any occurrence or process that involves a significant change in temperature or heat transfer, which can include physical phenomena like phase changes, chemical reactions that release or absorb heat, or events related to thermal runaway in a battery or other systems. As an example, the thermal event can include a failure of a battery and a subsequent occurrence of the fire.

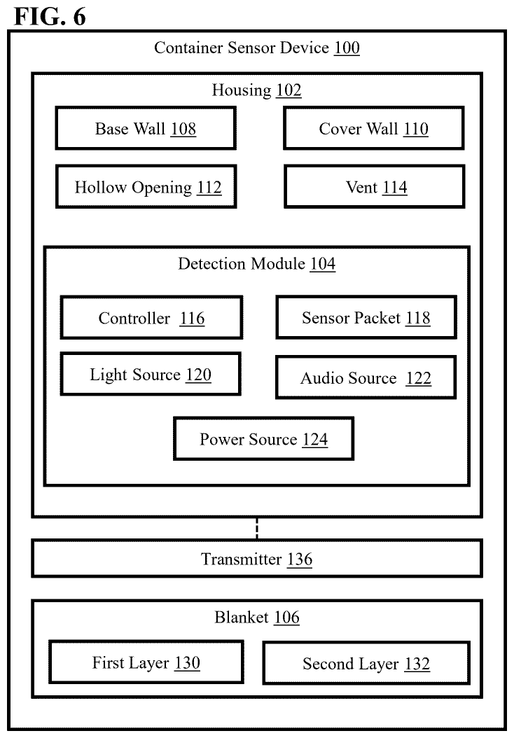

With reference to FIG. 6, the container sensor device 100 for detecting a thermal event within a container 101 can include a housing 102, a detection module 104 and a blanket 106. The container sensor device 100 can be installed or configured for use with any preexisting container 101, requiring minimal modifications to the container. As shown in FIGS. 1-2, the housing 102 of the container sensor device 100 can be coupled to an outer surface 103 of the container 101. The container 101 can include a recess 105 for which the housing 102 can be disposed within, creating a flush surface with the outer surface 103 of the container 101. Advantageously, installing the container sensor device 100 within a recess 105 of the container 101 can militate against the container sensor device 100 being damaged or removed from the container 101 while in use or during loading, unloading, and transport. Alternatively, the housing 102 can be retrofitted onto the container 101 and protrude from the outer surface 103 of the container 101. A skilled artisan can select a suitable placement for the housing 102 with respect to the outer surface 103 of the container 101 within the scope of the present disclosure.

It should be appreciated that the housing 102 can be formed of a rigid material. As an example, the housing 102 can be formed using a rigid material having an IP66 rating. An IP66 rating is part of the International Protection (IP) code, which classifies the degrees of protection provided by enclosures for electrical equipment against intrusion, dust, and water. This rating signifies that the housing 102 can be completely dust-tight, offering maximum protection against dust particles, and can withstand powerful water jets from any direction without water ingress, making it highly resistant to water, which can be useful during extinguishing of a thermal event to improve the lifespan of the detection module 104 for reuse. For example, the housing 102 can be formed of stainless steel or aluminum, or even high-quality plastics like polycarbonate or acrylonitrile butadiene styrene (ABS). A skilled artisan can select a suitable type of material for the housing 102 within the scope of the present disclosure.

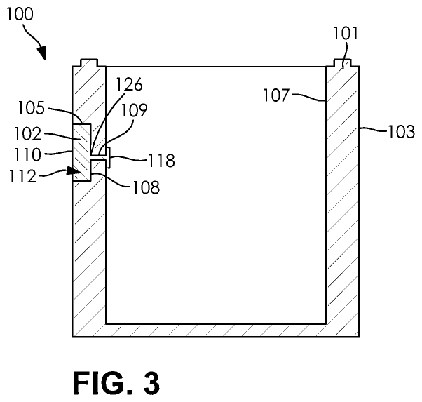

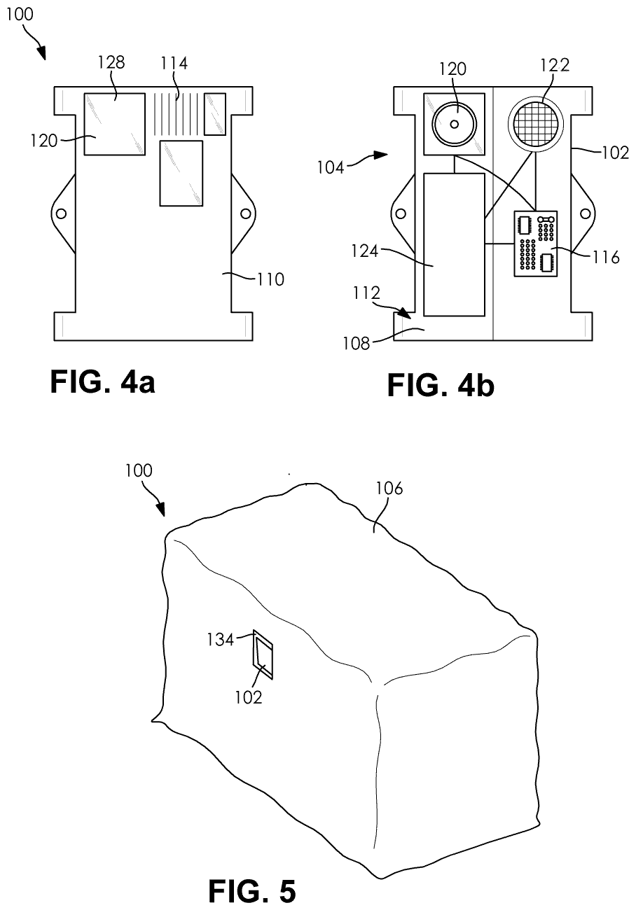

With reference to FIGS. 4a-4b, the housing 102 can include a base wall 108, a cover wall 110, and a hollow interior 112. The base wall 108 can be configured to be disposed adjacent the outer surface 103 of the container 101, as shown in FIG. 3. The cover wall 110 can be coupled opposite the base wall 108 and can act as a door for the user to access the internal components stored within the housing. The housing 102 can be sealed using rubber or silicone gaskets disposed on either of the base wall 108 and the cover wall 110, which provide a watertight and dustproof seal. As an example, the cover wall 110 can include a hinged edge to allow the housing 102 to be opened and closed. Alternatively, the cover wall 110 can include a lip for snapping onto the base wall 108. A skilled artisan can select a suitable means for coupling the base wall 108 and the cover wall 110.

As shown in FIG. 4a, the housing 102 can include a vent 114 for allowing airflow into the hollow interior 112 of the housing 102 to ventilate the components of the detection module 104. The vent 114 can be disposed on the base wall 108, the cover wall 110, or combinations thereof. A skilled artisan can select a suitable placement for the vent 114 within the scope of the present disclosure.

As shown in FIG. 6, the container sensor device 100 can include the detection module 104. The detection module 104 can include a controller 116, a sensor packet 118, a light source 120, an audio source 122, and a power source 124. With reference to FIG. 4b, the controller 116, the light source 120, the audio source 122, and the power source 124 can be disposed within the hollow interior 112. The sensor packet 118 can be disposed outside of the housing 102 within the container 101 to best detect a thermal event. The detection module 104 can provide monitoring through the sensor packet 118, capable of detecting various indicators of thermal events such as heat, humidity, pressure, and housing 102 tilt. The real-time data processing capabilities of the detection module 104 allow for quick analysis and response to a fire hazard. An alert system, including both visual notification via the light source 120 and/or audio notification via the audio source 122, can facilitate immediate local awareness of detected issues.

With reference to FIG. 3, the detection module 104 can include the sensor packet 118. The sensor packet 118 can include one or more sensors capable of detecting the thermal event and monitoring for a thermal event associated with a container 101. Specifically, the sensor packet 118 can include one or more sensors for detecting heat, heat vented rise, humidity, pressure, and tilt of the housing 102. The sensor within the sensor packet 118 can work together to provide comprehensive environmental monitoring, allowing the container sensor device 100 to detect a fire hazard or battery failures before the event escalates into elevated temperature, thermal runaway, or a fire, for example. The ability to monitor multiple parameters simultaneously can increase the sensitivity and accuracy of the container sensor device 100 in identifying thermal events.

The sensor packet 118 can be adaptable and can be strategically positioned within the container 101 on an inner surface 107, as shown in FIG. 3, and can be disposed adjacent to the contents of the container 101 such as a battery. Advantageously, disposing the sensor packet 118 on the inner surface 107 of the container 101 separately from the housing 102, the sensor packet 118 can be aligned with the areas of the container 101 most likely to experience a thermal event. Desirably, by positioning the sensor packet 118 on the inner surface 107 of the container 101 and positioning the housing 102 on the outer surface 103 of the container 101, the thermal event can be more easily detected by the sensor packet 118 and the housing 102 can be shielded from the thermal event by the container 101 itself. The sensor packet 118 can be disposed in an upper portion of the container 101. Because heat rises, any thermal event experienced by the container will cause heat to move to an uppermost portion of the container 101, where the sensor packet 118 can be positioned. In this way, the positioning of the sensor packet 118 allows for quick detection of environmental changes that might indicate a thermal event.

Where the sensor packet 118 is placed on the inner surface 107 of the container 101, the sensor packet 118 can be in wired communication with the controller 116 via an opening 109 in the container 101. It should be appreciated that the base wall 108 of the housing 102 can include an aperture 126 that corresponds with the opening 109 to allow for the wired communication to go from the sensor packet 118 through the container 101 and the housing 102 to the controller 116. The wired communication can utilize the opening 109 of the container 101 to allow for communication between the sensor packet 118 and the controller 116 even during a thermal event. Alternatively, the sensor packet 118 and the controller 116 can be in wireless communication. A skilled artisan can select a suitable communication means for the sensor packet 118 and the controller 116 within the scope of the present disclosure.

It should be appreciated that the data collected by the sensor packet 118, including data pertaining to heat, heat vented rise, humidity, and pressure, can be sent to the controller 116 within the detection module 104 for processing and analysis. Real-time data processing can allow for quick identification of a fire hazard, allowing for rapid response and alert generation.

The sensor packet 118 can be capable of detecting heat such that the sensor can detect changes in heat, specifically temperature increases or when the temperature exceeds a predetermined value. The controller 116, which can be communication with the sensor packet 118, can be programmed with a predetermined temperature threshold. When the sensor relays information to the controller 116 indicating that the threshold has been exceeded, the controller 116 can activate the alert system, including both visual and audio alerts. For example, if the temperature sensed by the sensor exceeds about 60° C., the controller 116 can be programmed to trigger an alert. As another example, the controller 116 can alert where a temperature differential of about 20° C. occurs within a given time period, such as about 2 seconds, which can signify thermal runaway. The predetermined thresholds can allow the container sensor device 100 to respond quickly to the thermal event, providing early warning to users through the light source 120 and audio source 122. A skilled artisan can select a suitable predetermined temperature and suitable predetermined temperature differential within the scope of the present disclosure.

The sensor packet 118 can detect changes in heat vented rise, specifically the rate at which heat is rising. The controller 116, which is in communication with the sensor packet 118, can be programmed with a predetermined threshold for heat vent rise. When the sensor relays information to the controller 116 indicating that the predetermined threshold has been exceeded, the controller 116 can activate the alert system, including both visual and audio alerts.

The container sensor device 100 can incorporate a smoke detector as part of the sensor packet 118 to detect smoke, which can be an indicator of the fire or the thermal event. The smoke detector can be a photoelectric smoke detector, an ionization smoke detector, or a combination thereof. A photoelectric smoke detector uses a light source and a photocell sensor. When smoke enters the sensing chamber, it scatters the light beam, causing some of the light to hit the photocell, which then triggers the alarm. A photoelectric smoke detector can be generally more responsive to smoldering fires. An ionization smoke detector, on the other hand, uses a small amount of radioactive material to ionize the air between two electrically charged plates. When smoke enters the chamber, it disrupts the ionization and reduces the current flowing between the plates, which can relay to the controller 116 to trigger the alert system. The ionization smoke detector can be more responsive to flaming fires. A skilled artisan can select a suitable smoke detector within the scope of the present disclosure.

The sensor packet 118 can also detect humidity and a change in humidity. The controller 116, which is in communication with the sensor packet 118, can be programmed with a predetermined threshold for humidity differential. When the sensor relays information to the controller 116 indicating that the predeterminer threshold has been exceeded, the controller 116 can activate the alert system, including both visual and audio alerts. Monitoring the humidity of the area around the product can indicate a thermal event. Specifically, a battery experiencing a thermal event, can lead to changes in humidity, albeit indirectly. When the battery overheats, the battery can release gases or vapors, which can include moisture, thus increasing humidity in the surrounding area. While the thermal event itself might not directly change humidity, the consequences can influence moisture levels in the environment.

For example, if the rate of humidity change detected by the sensor exceeds the predetermined threshold, such as humidity rising by about 10% to about 20% percentage increase per minute, the controller 116 can be programmed to trigger an alert. A skilled artisan can select a suitable predetermined threshold within the scope of the present disclosure.

The sensor packet 118 can detect pressure and, specifically, can detect a change in pressure. The controller 144 can be programmed with a predetermined threshold for pressure differential. When the sensor relays information to the controller 116 indicating that the predetermined threshold has been exceeded, the controller 116 can activate the alert system, including both visual and audio alerts. For example, if the rate of pressure change detected by the sensor exceeds the predetermined threshold, such as increasing at a rate of about 127 kPa per minute, the controller 116 can trigger an alert.

The sensor packet 118 can detect the tilt of the product at a predetermined angle of movement. The controller 116 can be programmed with the predetermined threshold angle that triggers an alert. The predetermined threshold angle can be carefully calibrated to be large enough to avoid false alarms from minor environmental tilts, such as someone leaning on the product, but small enough to detect a significant tilt that could be indicative of a thermal event. The predetermined threshold angle can include an angle between about 15° to about 20° from the normal position of the product. A skilled artisan can select a suitable predetermined angle threshold within the scope of the present disclosure.

It should be appreciated that the controller 116 can be configured to make determinations based on a combination of sensor data collected by the sensor packet 118. The configuration allows for more accurate detection of thermal events while militating against the likelihood of false alarms. For example, the controller 116 can be programmed to require at least two of the predetermined thresholds to be met before triggering the alert system. By utilizing data from multiple sensors simultaneously, such as temperature, humidity, pressure, and tilt, the controller 114 can perform a more comprehensive analysis of the condition of the product. The multi-factor approach enhances the reliability of the detection system, as it militates against a single anomalous reading triggering an unnecessary alert. For instance, a slight increase in temperature alone might not necessarily indicate a thermal event, but if accompanied by a rapid change in pressure or an unusual tilt angle, it could more reliably suggest a hazard.

As an example, the controller 116 can include a DNOC unit configured for detection (D), notification (N), operations (O), and communication (C). The controller 116 can coordinate and manage various functions of the container sensor device 100, including data analysis to identify the thermal events or fire hazards, alert triggering to activate the light source and audio source for visual and audio alerts, communication management for transmitting alert signals to external user devices when remote communication is enabled, and power management to ensure efficient operation of all components within the detection module 104.

It should be appreciated that the controller 116 can include a memory (internal or external), which can be coupled to one or more processors for storing information and instructions that can be executed by the processor. The memory can be one or more memories and of any type suitable to the local application environment and can be implemented using any suitable volatile or nonvolatile data storage technology such as a semiconductor-based memory device, a magnetic memory device and system, an optical memory device and system, fixed memory, and removable memory. For example, the memory can consist of any combination of random-access memory (RAM), read only memory (ROM), static storage such as a magnetic or optical disk, hard disk drive (HDD), or any other type of non-transitory machine or computer readable media. The instructions stored in the memory can include program instructions or computer program code that, when executed by the process, enable the at least container sensor device 100 to perform tasks as described herein.

One skilled in the art will also appreciate that one or more processors can be configured for processing information and executing instructions or operations. The processor can be any type of general or specific purpose processor. In some cases, multiple processors for the at least one processor can be utilized according to other embodiments. In fact, the one or more of the processors can include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. In some cases, the one or more of the processor can be remote from the container sensor device 100, such as disposed within a remote platform.

The one or more processors can perform functions associated with the operation of the container sensor device 100 which can include, for example, precoding of antenna gain/phase parameters, encoding and decoding of individual bits forming a communication message, formatting of information, and overall control of the one or more computing platforms, including processes related to management of communication resources.

The memory can also store a plurality of modules including the machine-readable instructions, which can be provided as tangible, non-transitory processor executable instructions, as a non-limiting example. The instructions can be configured to execute a method 300 of the present disclosure as described herein, by the processor or the other processors of the container sensor device 100 as detailed hereinabove.

In certain embodiments, one or more computing platforms can also include or be coupled to one or more antennas (not shown) for transmitting and receiving signals and/or data to and from the container sensor device 100. The one or more antennas can be configured to communicate via, for example, a plurality of radio interfaces that can be coupled to the one or more antennas. The radio interfaces can correspond to a plurality of radio access technologies including one or more of LTE, 5G, WLAN, Bluetooth, near field communication (NFC), radio frequency identifier (RFID), ultrawideband (UWB), and the like. The radio interface can include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

As shown in FIG. 4b, the detection module 104 can include the light source 120, which is in direct communication with the controller 116. The light source 120 can be disposed on the housing 102 to allow for the light source 120 to be visible when in operation, as shown in FIG. 4a. Direct communication can allow the light source 120 to be activated promptly when the controller 116 processes data from the sensor packet 118 and determines that a thermal event is occurring. The light source 120 can provide a visual alert to nearby users or occupants when a thermal event is detected. The light source 120 can include an LED light that flashes or provides a strobe effect when providing the visual alert. The flashing nature of the LED light can increase visibility and draw immediate attention, even in potentially smoky or chaotic environments that might accompany a fire or thermal event. Additionally, where there are multiple container sensor devices 100 in an area, the light source 120 can assist the user in determining which container 101 is experiencing a thermal event.

In certain embodiments, the light source 120 can be strategically positioned on the housing 102 to maximize the effectiveness of the visual alert. For example, the light source 120 can be disposed on an exterior of the cover wall 110 of the housing 102 to allow for the visual alert to be easily seen. Alternatively, the light source 120 can be disposed within the housing 102 and the housing 102 can include a housing opening 128 disposed adjacent the light source 120 in the housing 102 to allow for the visual alert created by the light source 120 to be visible outside of the housing 102. Advantageously, positioning the light source 120 on the housing 102 or within the housing 102 with the housing opening 128 can allow for the visual alert to be prominently displayed close to eye level and easily noticeable from various angles.

The light source 120 can work in conjunction with other components of the detection module 104. While the light source 120 provides visual alerts, the audio source 122 can provide an audio alert, creating a multi-sensory warning system. The combination of the visual alert and the audio alert can increase the overall effectiveness of the container sensor device 100 in notifying nearby individuals of a fire hazard.

With reference to FIG. 4b, the detection module 104 can include the audio source 122, which can be in direct communication with the controller 116. Direct communication can allow the audio source 122 to be activated promptly when the controller 116 processes data from the sensor packet 118 and determines that a thermal event is occurring. The audio source 122 can be disposed within the housing 102. The audio source 122 can provide an audio alert to nearby users or occupants when a thermal event is detected. Advantageously, the vent 114 can allow for the audio alert to be more easily heard as the venting space can allow for the audio created by the audio source 122 to easily escape the housing 102. In certain embodiments, the audio source 122 can include a piezoelectric audio source providing the audio alert. Advantageously, the piezoelectric audio source can produce clear, attention-grabbing sounds, for effectively alerting nearby individuals in potentially noisy or chaotic environments that might accompany a fire or thermal event. The audio source 122 can be small and lightweight to make for easy integration into the housing 102 without adding significant bulk or weight. Additionally, piezoelectric speakers can be resistant to temperature changes and humidity, which can occur during a thermal event.

As shown in FIG. 4b, the detection module 104 can include the power source 124 for supplying power to the detection module 104. The power source 124 can be disposed within the housing 102 to allow for the housing 102 to provide an additional layer of protection against the thermal event in addition to the container 101 itself. Protecting the power source 124 from a thermal event can increase the longevity of the container sensor device 100 and allow the power source 124 to operate continuously, even in situations where external power can be compromised.

The power source 124 can power all the components within the detection module 104, including the controller 116, the sensor packet 118, the light source 120, and the audio source 122. In certain embodiments, the power source 124 can include a battery for supplying power to the detection module 104. As an example, the battery can be a lithium-ion battery, a lithium polymer battery, an alkaline battery, a lithium iron phosphate (LiFePO4) battery, or a sealed lead-acid battery. A skilled artisan can select a suitable power source 124 within the scope of the present disclosure.

With reference to FIG. 5, the container sensor device 100 for detecting a thermal event of a container 101 can include a blanket 106 formed of a temperature resistant material. The blanket 106 can be customized to be formed in various sizes and shapes to accommodate containers of different shapes and sizes. The temperature-resistant material used can be cut, sewn, or molded to conform to the specific contours and dimensions of the container that the blanket 106 is intended to protect. The adaptability of the blanket 106 allows for the container sensor device 100 to provide comprehensive coverage, whether the container sensor device 100 is being used on a personal container or a cargo container containing a battery.

It should be appreciated that the blanket 106 can be formed with multiple layers. For example, the blanket 106 can be formed from a first layer 130 and a second layer 132. The first layer 130, which can be disposed adjacent to the container 101 and thus closest to a thermal event, can be made from a highly heat-resistant material. For example, the first layer 130 can be made from fiberglass or a carbonized fiber fabric. The first layer 130 can be lightweight and flexible, allowing the blanket 106 to easily be moved onto the container 101 and off of the container 101, particularly in the case of a thermal event. The first layer 130 can withstand a thermal event producing temperatures up to about 1000° C. The purpose of the first layer 130 is to provide immediate protection and containment of the thermal event. As an example, the first layer 130 can include a carbonized fiber fabric welding blanket commercially available as VELVET SHIELD® by Steiner Industries of Chicago, IL.

The second layer 132 can be disposed adjacent the first layer 130 and can be an outer layer of the blanket 106 disposed away from the container. The second layer 132 can include the same material as the first layer 130 or, alternatively, the second layer 132 can include a different material than the first layer 130. The second layer 132 can be made from a highly heat-resistant material. The second layer 132 can be formed from a rigid and durable material providing structural stability to the blanket 106, particularly during a thermal event. The second layer 132 can withstand a thermal event producing temperatures up to about 1000° C. The purpose of the second layer 132 is to provide secondary protection and additional insulation during the thermal event. As an example, the second layer 132 can include a HI TEMP Welding Blanket sold by HI-TEMP PRODUCTS of Danbury, CT.

With reference to FIG. 5, the blanket 106 can include a passage 134 that corresponds with the housing 102 when installed on the container 101. The passage 134 in the blanket 106 allows for the housing 102 of the container sensor device 100 to be seen through the blanket when it is installed on the container 101 such that the visual and audio alerts from the container sensor device 100 remain effective even when the blanket 106 is in place. The passage 134 can fit snugly around the housing 102 of the container sensor device 100, militating against any gap between the housing 102 and the passage 134. In this way, the tight fit serves to maintain the integrity of the coverage of the blanket 106 on the container 101, ensure that the visual alerts are clearly visible through the passage 134, and allows the audio alerts to be heard without significant muffling.

It should be appreciated that the container sensor device 100 can include more than one housing 102 and detection module 104. Multiple housings 102 and the detection modules 104 can be disposed around the container 101. Alternatively, the container sensor device 100 can include a housing 102 and detection module 104 in communication with more than one sensor packet 118. To accommodate the additional housings 102 and detection modules 104, the container 101 can have several openings 109 to allow for the sensor packet 118 of each detection module 104 to be disposed within the container 101. By placing more than one housing 102 and more than one detection module 104 at different locations on the container 101, the container sensor device 100 can have more comprehensive coverage of the entire container space, detecting thermal events or fires that can start in various areas depending upon the size of the container 101. The increased coverage can lead to faster detection, as the nearest module can pick up changes first. The redundancy provided by multiple modules aids with continuous protection even if one module fails or is damaged. Additionally, by collecting data from multiple points, it can be easier to pinpoint the exact location of a thermal event within the container 101, improving the accuracy of the information gathered. Multiple modules could work together to provide more sophisticated alerts, reducing false alarms by cross-referencing data from different locations.

The present disclosure further provides a system 200 for detecting the occurrence of a thermal event, shown generally in FIGS. 7-8. The system 200 can include the container and the container sensor device 100 as described herein, and a user device 202. The user device 202 can be in communication with the container sensor device 100 and can be configured to receive a signal indicative of an alert from the container sensor device 100. The user device 202 can serve as a remote interface for receiving alerts and notifications from the detection module 104. The user device 202 can extend the alert reach beyond the immediate vicinity of the container or product being monitored.

As described herein, the detection module 104 can be configured to provide an audio and visual alert to a nearby user upon detecting an onset or occurrence of a thermal event. The detection module 104 can further include a transmitter 136 or transmitter in communication with the controller 116. The detection module 104 can be configured to transmit a signal by the transmitter 136 or transmitter indicative of the detected thermal event to the user device 202. The communication allows for remote monitoring and rapid response to fire hazards, even when the user is not in close proximity to the container sensor device 100.

As examples, the user device 202 can include a smart phone, a smart watch, a tablet, a networked computer, a laptop computer, a smart home device, a vehicle information system, an industrial control panel, a radio, a pager, a remote device dedicated to wireless communication with the container sensor device 100, other various wirelessly connected devices, and combinations thereof. A skilled artisan can select a suitable user device 202 within the scope of the present disclosure.

By incorporating the user device 202, the effectiveness of the container sensor device 100 can extend beyond just local alerts. The remote notification capability of the user device 202 can allow for quicker response times and more effective mitigation of thermal events, as users can be alerted and take action even when they are not in the immediate vicinity of the monitored container or product.

The present disclosure can also provide a method 300 for detecting the occurrence of a thermal event, shown generally in FIG. 9. The method 300 can include a step 302 of providing the container sensor device 100 as described herein. The method 300 can include a step 304 of providing a container 101 as described herein. The container sensor device 100 can be installed onto the outer surface 103 of the container adjacent to the opening 109 formed in the container 101 in a step 306. The method 300 can include a step 308 of monitoring the container 101 with the container sensor device 100 and a step 310 of alerting a user in case of the thermal event being detected by the monitoring of the container 101.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A container sensor device for detecting a thermal event in a container, comprising:
a housing having a base wall, a cover wall, and a hollow interior, and the base wall configured to be disposed adjacent an outer surface of the container;
a detection module disposed adjacent the housing, the detection module including
a sensor packet including a sensor for detecting the thermal event, the sensor being configured to detect a member selected from a group consisting of heat, heat vented rise, smoke, humidity, pressure, tilt of the housing, and combinations thereof,
a controller in communication with the sensor packet, the controller configured to receive and process data from the sensor packet,
a light source in communication with the controller, the light source configured to provide a visual alert upon receiving an alert from the controller that the sensor has detected a thermal event,
an audio source in communication with the controller, the audio source configured to provide an audio alert upon receiving an alert from the controller that the sensor has detected a thermal event, and
a power source for supplying power to the detection module; and
a blanket including a temperature resistant material, the blanket formed to cover the container.

2. The container sensor device of claim 1, wherein the detection module further includes a transmitter in communication with the controller.

3. The container sensor device of claim 2, wherein the detection module is configured to transmit a signal by the transmitter indicative of the thermal event to a user device including at least one of a mobile phone and a networked computer.

4. The container sensor device of claim 1, wherein the light source includes an LED light.

5. The container sensor device of claim 1, wherein the audio source includes a piezoelectric speaker.

6. The container sensor device of claim 1, wherein the power source includes a battery.

7. The container sensor device of claim 1, wherein the blanket includes a passage that corresponds with the housing when installed on the container.

8. The container sensor device of claim 7, wherein the passage in the blanket is disposed around a perimeter of the housing of the container sensor device.

9. The container sensor device of claim 1, further comprising multiple detection modules disposed at different locations on the container.

10. The container sensor device of claim 1, wherein the sensor packet is disposed on an inner surface of the container.

11. The container sensor device of claim 1, wherein the sensor packet is in wired communication with the controller.

12. The container sensor device of claim 1, wherein the base wall of the housing includes an aperture.

13. The container sensor device of claim 1, wherein the cover wall includes a vent for allowing airflow into the hollow interior of the housing.

14. The container sensor device of claim 1, wherein the light source is disposed within the housing and the housing includes a housing opening disposed adjacent the light source to allow for the visual alert to be visible outside of the housing.

15. The container sensor device of claim 1, wherein the container includes a battery.

16. A system for detecting an occurrence of a thermal event, comprising:
a container with an outer surface and an opening formed therethrough, the container at risk of the thermal event;
a container sensor device including
a housing having a base wall, a cover wall, and a hollow interior, and the base wall configured to be disposed adjacent an outer surface of the container;
a detection module disposed adjacent the housing, the detection module including
a sensor packet including a sensor for detecting the thermal event, the sensor being configured to detect a member selected from a group consisting of heat, heat vented rise, smoke, humidity, pressure, tilt of the housing, and combinations thereof,
a controller in communication with the sensor packet, the controller configured to receive and process data from the sensor packet,
a light source in communication with the controller, the light source configured to provide a visual alert upon receiving an alert from the controller that the sensor has detected a thermal event,
an audio source in communication with the controller, the audio source configured to provide an audio alert upon receiving an alert from the controller that the sensor has detected a thermal event, and
a power source for supplying power to the detection module; and
a blanket including a temperature resistant material, the blanket formed to cover the container; and
a user device in communication with the container sensor device and configured to receive a signal indicative of an alert from the container sensor device.

17. The system of claim 16, wherein the container holds a battery.

18. The system of claim 16, wherein the housing is configured to be disposed within a recess on the outer surface of the container.

19. A method for detecting an occurrence of a thermal event, the method comprising steps of:
providing a container with an outer surface and an opening formed therethrough, the container at risk of the thermal event;
providing a container sensor device, including
a housing having a base wall, a cover wall, and a hollow interior, and the base wall configured to be disposed adjacent an outer surface of the container;
a detection module disposed adjacent the housing, the detection module including
a sensor packet including a sensor for detecting the thermal event, the sensor being configured to detect a member selected from a group consisting of heat, heat vented rise, smoke, humidity, pressure, tilt of the housing, and combinations thereof,
a controller in communication with the sensor packet, the controller configured to receive and process data from the sensor packet,
a light source in communication with the controller, the light source configured to provide a visual alert upon receiving an alert from the controller that the sensor has detected a thermal event,
an audio source in communication with the controller, the audio source configured to provide an audio alert upon receiving an alert from the controller that the sensor has detected a thermal event, and
a power source for supplying power to the detection module, and
a blanket including a temperature resistant material, the blanket formed to cover the container;
installing the container sensor device onto the outer surface of the container adjacent to the opening formed in the container;
monitoring the container with the container sensor device; and
providing an alert upon detecting the thermal event while monitoring the container.

20. The method of claim 19, wherein the container holds a battery.
